(19) United States
(12) Patent Application Publication
(10) Pub. No.: US 2023/0243291 A1
(43) Pub. Date: Aug. 3, 2023

(54) PRECHAMBER JET DISTURBANCE INTENSIFIED COMBUSTION SYSTEM

(71) Applicant: TIANJIN UNIVERSITY, Tianjin (CN)

(72) Inventors: Wanhua SU, Tianjin (CN); Binyang WU, Tianjin (CN)

(21) Appl. No.: 17/768,171

(22) PCT Filed: Nov. 20, 2019
(86) PCT No.: PCT/CN2019/119635

§ 371 Date: Apr. 11, 2022

(30) Foreign Application Priority Data
Oct. 10, 2019 (CN) 201910957218.9

(51) Int. Cl. F02B 19/10; F02B 19/18

(52) U.S. Cl. CPC F02B 19/108; F02B 19/1095; F02B 19/1014; F02B 19/18

(57) ABSTRACT

The present invention discloses a prechamber jet disturbance intensified combustion system, comprising a main combustion chamber and a main fuel injector, the lower end of a fuel nozzle of the main fuel injector is located inside the main combustion chamber; a plurality of prechambers are arranged outside the main combustion chamber, the prechambers are connected with the main combustion chamber by prechamber channels, an auxiliary fuel injector is arranged outside each prechamber, and the lower end of a fuel nozzle of the auxiliary fuel injector is located inside the corresponding prechamber. The present invention abandons layout and combustion process idea of an existing heavy-duty diesel engine combustion system, which remarkably increases the mixing rate of fuel and air and the combustion rate by using autonomous and controllable parts, materials and process conditions.

### CROSS-REFERENCE TO RELATED APPLICATIONS

This Application is a national stage application of PCT/CN2019/119635. This application claims priorities from PCT Application No. PCT/CN2019/119635, filed Nov. 20, 2019, and from the Chinese patent application 2019109572189 filed Oct. 10, 2019, the content of which are incorporated herein in the entirety by reference.

### FIELD OF THE APPLICATION

The present invention relates to a combustion system, in particular to a prechamber jet disturbance intensified combustion system.

### BACKGROUND ART

The difficulty of combustion intensification of a high-power and large-displacement diesel engine lies in that on one hand, a fuel system cannot achieve high injection pressure and injection rate, and on the other hand, the mixing rate of fuel and air cannot meet the requirements of high-power intensified combustion. How to increase the fuel-air mixing rate and the combustion rate is a key for achieving high specific power of the engine, and rapid and intensified combustion in the engine.

### BRIEF SUMMARY OF THE INVENTION

The present invention aims at overcoming the defects in the prior art, and developing a prechamber jet disturbance intensified combustion system. The combustion system abandons layout and combustion process idea of an existing heavy-duty diesel engine combustion system, which remarkably increases the fuel-air mixing rate and the combustion rate by using autonomous and controllable parts, materials and process conditions.

The objective of the present invention is achieved by the following technical solution.

The prechamber jet disturbance intensified combustion system of the present invention comprises a main combustion chamber and a main fuel injector, the lower end of a fuel nozzle of the main fuel injector is located inside the main combustion chamber, and two prechambers are arranged above the main combustion chamber, the prechambers are connected with the main combustion chamber by prechamber channels. An auxiliary fuel injector is arranged outside each prechamber, the auxiliary fuel injectors are located on the two sides of the main fuel injector respectively, and the lower end of a fuel nozzle of the auxiliary fuel injector is located inside the corresponding prechamber.

Detonation of the prechambers is formed and converted into outlet gas momentum, the number of the prechambers is at least one, the shape of the prechambers is selected from spherical, cylindrical or pyriform, and injecting manner of the prechambers is selected from injecting along the tangential direction of a cylinder, injecting toward the center of the cylinder or injecting in the opposite direction of the jets of main chamber injector.

Through the prechamber channels, high-pressure potential energy of the prechambers is converted into high outlet gas momentum, so the prechamber channels need to meet the requirements of low flow resistance of compressed gas inlet and high combustion injecting momentum outlet; and the number of the prechamber channels is at least one, and the shape of the prechamber channels are selected from a shrinking-broadening shape, a gradually-broadening shape, a gradually-shrinking shape or a cylinder shape.

The main fuel injector and the auxiliary fuel injectors adopt the same common rail or different common rails.

Compared with the prior art, the technical solution of the present invention has the following beneficial effects:

According to the prechamber jet disturbance intensified combustion system of the present invention, on one hand, the problem of the fuel system cannot achieve high injection pressure and injection rate can be solved, on the other hand, by controlling the pressure difference between the main combustion chamber and the prechambers, high-speed airflow is injected into the main combustion chamber when a large quantity of over-rich mixture is distributed in the main combustion chamber, an intensive airflow disturbance is formed in the main combustion chamber, so as to increase the fuel-air mixing rate in the main combustion chamber, and achieve intensified combustion.

The auxiliary fuel injectors inject fuel near the top dead center between compression and power stroke, fuel combusts rapidly in the prechambers, high-pressure potential energy can be formed in the prechambers, and high-speed airflow can be instantly injected when a large quantity of over-rich mixture is distributed in the main combustion chamber, so as to promote a strong axial and circumferential airflow movement in the main combustion chamber, thereby greatly improving the fuel-air mixing process and increasing the combustion rate.

There is an included angle between the prechamber channels and the upper surface of the main combustion chamber, which aims to form tumble flow in the prechambers during the piston upward movement in the compression stroke, so as to promote airflow movement in the prechambers, and on the other hand, the depth and width of disturbance of high-speed jet gas of the prechambers in the main combustion chamber can be improved due to the arrangement manner.

### BRIEF DESCRIPTION OF THE DRAWINGS

FIG. 1 is a schematic diagram of a prechamber jet disturbance intensified combustion system of the present invention;

FIGS. 2A-2C show different shapes of the prechamber according to the present invention, wherein FIG. 2A shows a spherical shape, FIG. 2B shows a cylindrical shape, and FIG. 2C shows a pyriform shape;

FIGS. 3A-3B are comparison diagrams of volumes of the prechamber in the present invention (taking spherical as an example);

FIG. 4 is a schematic diagram of the prechamber in the present invention;

FIGS. 5A-5D show different shapes of the prechamber channel according to the present invention, wherein FIG. 5A shows a shrinking-broadening shape, FIG. 5B shows a gradually-broadening shape, FIG. 5C shows a gradually-shrinking shape, and FIG. 5D shows a cylinder shape;

FIGS. 6A-6C show different angles of the prechamber channel according to the present invention; and

FIG. 7A-7C show different size of the prechamber channel according to the present invention (taking a cylindrical channel as an example).

In the drawings:

| | |
|---|---|
| 1: main combustion chamber | 2: prechamber |
| 3: prechamber channel | 4: main fuel injector |
| 5: auxiliary fuel injector | |

### DETAILED DESCRIPTION OF THE PRESENT INVENTION

The present invention will be further explained with reference to drawings and embodiments, but the following embodiments are not intended to limit the present invention.

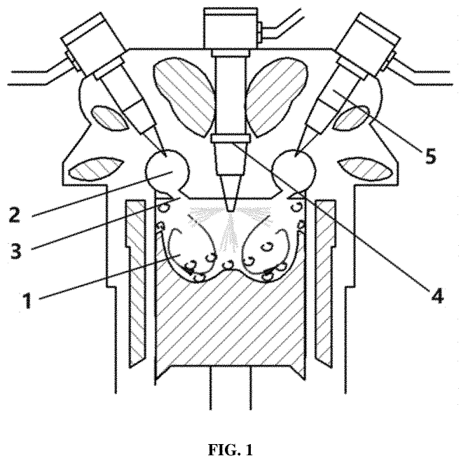

As shown in FIG. 1, the present invention provides a prechamber jet disturbance intensified combustion system, comprises a main combustion chamber 1 and a main fuel injector 4, the lower end of a fuel nozzle of the main fuel injector 4 is located inside the main combustion chamber 1, two prechambers 2 are arranged above the main combustion chamber 1, the prechambers 2 are connected with the main combustion chamber 1 by prechamber channels 3, an auxiliary fuel injector 5 is arranged outside each prechamber 2, the auxiliary fuel injectors 5 are located on the two sides of the main fuel injector 4 respectively, and the lower end of a fuel nozzle of the auxiliary fuel injector 5 is located inside the corresponding prechamber 2. The fuel is injected by the auxiliary fuel injectors 5 at the top dead center between compression and power stroke, fuel combusts rapidly in the prechambers, thus detonation is formed in the prechambers and high-pressure potential energy in prechamber is converted into outlet gas momentum. High-speed airflow is instantly injected when a large quantity of over-rich mixture is distribute in the main combustion chamber 1, so as to promote a strong axial and circumferential airflow movement in the main combustion chamber, thereby greatly improving the fuel-air mixing process and increasing the combustion rate.

During compression stroke, airflow in the main combustion chamber 1 formed weak turbulence or free of turbulence, the influences of the structure and characteristic scale of the main combustion chamber 1 on a turbulent kinetic energy and scalar dissipation rate space-time spectrum are analyzed based on the followings: the structural size of the main combustion chamber 1, gas momentum and heat flow at nozzle outlet of the prechambers 2, and the transitive relation between charge momentum and heat of the main combustion chamber 1, so that the structure and dimension of the main combustion chamber with the high mixing rate can be provided, which comprise the diameter of the main combustion chamber 1, a convergent surface arc, a center boss and other critical microscales.

In the present invention, high-pressure potential energy is formed by detonation of the prechambers 2 and converted into momentum disturbing the main combustion chamber 1 through the prechamber channels 3, so as to form intensive turbulent movement in the main combustion chamber 1. Detonation of the prechambers 2 is formed and converted into outlet gas momentum. In the present invention, key factors for forming high potential energy in the prechambers 2 are obtained by investigating the structure and dimension of the prechambers 2, such as number, shape, prechamber arrangement manner, prechamber volume ratio and other parameters, so as to design structure and size solutions of the prechambers 2.

(1) Number of the prechambers 2: the number of the prechambers 2 may be one or more, for example, may be designed into one, two, three, four, etc., and may not be excess usually.

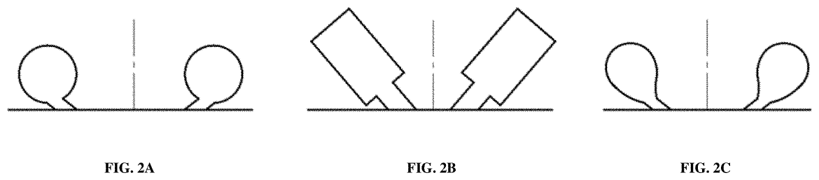

(2) Shape of the prechambers 2: the shape of the prechambers 2 can be spherical, cylindrical or pyriform, etc., as shown in FIGS. 2A-2C.

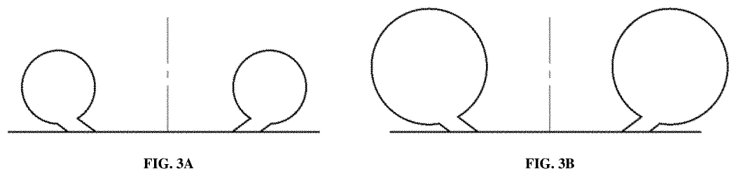

(3) Size of the prechambers 2: the volume ratio of the prechambers plays an important role in detonation formed in the prechambers 2 to further achieve high potential energy, as shown in FIGS. 3A-3B.

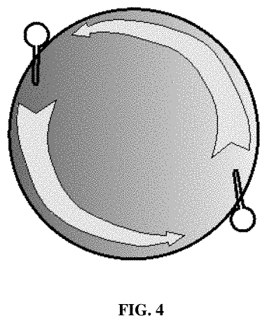

(4) Arrangement of the prechambers 2: injecting manner of the prechambers 2 may be injecting along the tangential direction of a cylinder, injecting toward the center of the cylinder or injecting in the opposite direction of the jets of main chamber injector, as shown in FIG. 4.

In the present invention, the rule of converting pressure potential energy into kinetic energy during “injecting” process. The gas inlet circulation capacity of the prechambers 2 under the pressure difference formed during compression stroke are obtained by studying the number, shape, dimension and other parameters of the prechamber channels 3. High-pressure potential energy of the prechambers 2 is converted into high momentum through the prechamber channels 3, and meet the requirements of low flow resistance of compressed gas inlet and high combustion injecting momentum outlet. The number of the prechamber channels 3 may be one or more, one prechamber 2 corresponds to one prechamber channel 3, and the dimension of the prechamber channels 3 includes length, hole diameter, segmented molded line, etc.

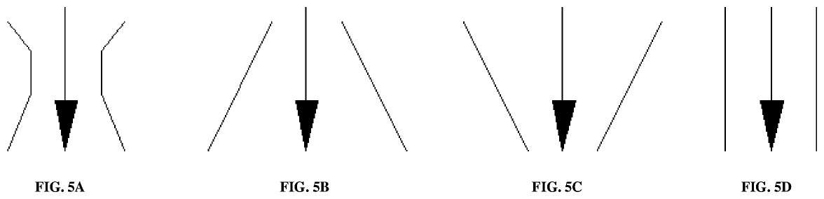

(1) Shape of the prechamber channels 3: a shrinking-broadening shape, a gradually-broadening shape, a gradually-shrinking shape or a cylinder shape can be adopted, as shown in FIGS. 5A-5D.

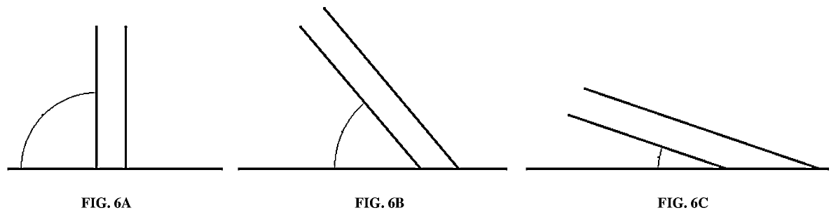

(2) Angle of the prechamber channels 3: the included angle between the prechamber channels 3 and the upper surface of the main combustion chamber 1 (e.g. the bottom of the engine cylinder head) depends on the position of the target area disturbed by jet; wherein, as shown in FIG. 6A, the included angle between the prechamber channels 3 and the upper surface of the main combustion chamber 1 is 90°, by arranging the prechamber channels 3 in this way, high-speed gas injected through the prechamber channels 3 can be rapidly injected into the bottom of a piston in the main combustion chamber 1, thus obviously promoting the fuel-air mixing rate at the bottom of in the main combustion chamber 1, and reducing the mass of diesel-soot at the bottom of the main combustion chamber 1 during combustion process, and increasing the combustion rate in the main combustion chamber. As shown in FIG. 6B, the included angle between the prechamber channels 3 and the upper surface of the main combustion chamber 1 is 50°, by arranging the prechamber channels 3 in this way, high-speed gas injected through the prechamber channels 3 is divided into two parts on the piston wall in the main combustion chamber 1, one part moves upwards along the piston wall, promotes the air entrainment movement in the center of the main combustion chamber 1 simultaneous, so as to increase the fuel-air mixing rate and the combustion rate in the center of the piston; the other part moves downwards along the piston wall, and promotes the air entrainment movement in the bottom of the main combustion chamber 1 simultaneous, so as to increase the fuel-air mixing rate in the area and reduce pollutants generated during combustion. And as shown in FIG. 6C, the included angle between the prechamber channels 3 and the upper surface of the main combustion chamber 1 is 20°, by arranging the prechamber channels 3 in this way, high-speed gas injected through the prechamber channels 3 promotes fuel-air mixing effect in the center of the main combustion chamber 1, and meanwhile, when the piston moves downwards during the power stroke, the high-speed gas injected through the prechamber channels 3 can bypass the center of the piston to reach the opposite side of the main combustion chamber 1 where the prechamber channels 3 are located, thereby increasing the fuel-air mixing rate of the region of the main combustion chamber 1 away from the prechamber channels 3, and increasing the combustion rate in the main combustion chamber 1.

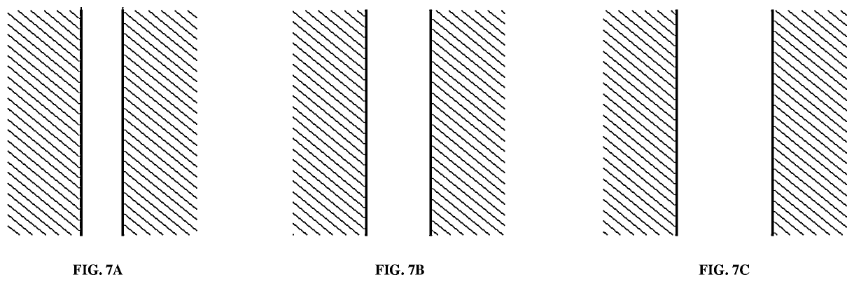

(3) Size of the prechamber channels 3: (taking a cylindrical channel as an example), as shown in FIGS. 7A-7C.

The present invention developed the structural design, arrangement manner and injecting strategy of the injector nozzles of the main fuel injector 4 and the auxiliary fuel injectors 5 based on the mechanism of the spraying characteristic in a complex flow field, which comprise the number, diameter, angle and arrangement solution of the injector nozzles of the fuel injectors. The main fuel injector 4 and the auxiliary fuel injectors 5 may share the same common rail, and optionally, may also use different common rails respectively.

According to the prechamber jet disturbance intensified combustion system of the present invention, by controlling the pressure difference between the main combustion chamber and the prechambers, high-speed airflow is injected in the main combustion chamber 1 when a large quantity of over-rich mixture is distributed in the main combustion chamber 1, intensive airflow disturbance is formed in the main combustion chamber 1, so as to increase the fuel-air mixing rate in the main combustion chamber 1, and achieve intensified combustion and increase the engine power density.

The prechamber jet disturbance intensified combustion of the present invention is proposed according to the following steps: (1) obtaining a structural shape solution of the main combustion chamber 1 according to the influences of the structure and dimension of the main combustion chamber 1 on the turbulent kinetic and scalar dissipation rate spectrum; (2) obtaining a shape and arrangement solution of the prechamber channels 3 based on the influences of the shape and arrangement of the injector nozzles of the prechambers on the turbulent kinetic and scalar dissipation rate spectrum of the main combustion chamber; (3) obtaining a structural shape solution of the prechambers 2 according to detonation of the prechambers 2 and its influences on outlet gas momentum; and (4) obtaining a structural design and arrangement solution of injector nozzles of the main-auxiliary fuel system according to the spraying characteristic in the complex flow field in the main combustion chamber and the prechambers.

Although it has been described with reference to the drawings, the present invention is still not limited to the above implementation. The above implementation is not construed as a limitation, but is merely illustrative. A person of ordinary skill in the art can further make several many variants under the reveal of the present invention without departing from the purpose of the present invention, and those variants should be included in the protection scope of the present invention.

1. A prechamber jet disturbance intensified combustion system, comprising a main combustion chamber (1) and a main fuel injector (4), the lower end of a fuel nozzle of the main fuel injector (4) is located inside the main combustion chamber (1);
wherein, two prechambers (2) are arranged above the main combustion chamber (1), the prechambers (2) are connected with the main combustion chamber (1) by prechamber channels (3), an auxiliary fuel injector (5) is arranged outside each prechamber (2), the auxiliary fuel injectors (5) are located on the two sides of the main fuel injector (4) respectively, and the lower end of a fuel nozzle of the auxiliary fuel injector (5) is located inside the corresponding prechamber (2).
wherein, through the prechamber channels (3), high-pressure potential energy of the prechambers being converted into high outlet gas momentum, so the prechamber channels (3) need to meet the requirements of low flow resistance of compressed gas inlet and high combustion injecting momentum outlet; and the number of the prechamber channels is at least one, and the shape of the prechamber channels are selected from a shrinking-broadening shape, a gradually-broadening shape, a gradually-shrinking shape or a cylinder shape.

2. The prechamber jet disturbance intensified combustion system according to claim 1, wherein the detonation of the prechambers (2) is formed and converted into outlet gas momentum, the number of the prechambers (2) is at least one, the shape of the prechambers (2) is selected from spherical, cylindrical or pyriform, and injecting manner of the prechambers (2) is selected from injecting along the tangential direction of a cylinder, injecting toward the center of the cylinder or injecting in the opposite direction of the injectors of main chamber injector.

3. (canceled)

4. The prechamber jet disturbance intensified combustion system according to claim 1, wherein the main fuel injector (4) and the auxiliary fuel injectors (5) adopt the same common rail or different common rails.
